(19) United States
(12) Patent Application Publication
(10) Pub. No.: US 2020/0010147 A1
(43) Pub. Date: Jan. 9, 2020

(54) ASYMMETRICAL ELLIPTICAL CHAINRING FOR CLIPLESS PEDAL

(71) Applicant: Yun Seok CHOI, Daegu (KR)

(72) Inventor: Yun Seok CHOI, Daegu (KR)

(21) Appl. No.: 16/340,109

(22) PCT Filed: Sep. 29, 2017
(86) PCT No.: PCT/KR2017/010910

§ 371 Date: Apr. 6, 2019

(30) Foreign Application Priority Data
Oct. 6, 2016 (KR) 10-2016-0129718
Sep. 28, 2017 (KR) 10-2017-0125683

(51) Int. Cl. B62M 9/08; B62M 3/06; F16H 55/30

(52) U.S. Cl. CPC B62M 9/08; B62M 2009/002; F16H 55/30; B62M 3/06

(57) ABSTRACT

The present invention relates to an asymmetric elliptical chainring for a clipless pedal, wherein a slope at each imaginary point of a first to second elliptical section increases counterclockwise, a slope at each imaginary point of a third elliptical section decreases counterclockwise, a virtual center line in a longitudinal direction of a crank arm is located so as to have a set angle in the counterclockwise direction from a starting point of the first elliptical section, the starting point of the first elliptical section is the shortest distance from a center of an asymmetric ellipse, has a curve of a first set curvature or less, and forms a first angular section from the starting point of the first elliptical section, a start point of the second elliptical section meets an end point of the first elliptical section located within a first near transition section, the end point of the second elliptical section is the longest distance from the center of the asymmetric ellipse, a curvature of the second elliptical section is equal to or less than the first set curvature, the second elliptical section forms a second angular section from the starting point of the second elliptical section, a starting point of the third elliptical section is an end point of a second near transition section located between an end point of the second elliptical section, and a curvature of the third elliptical section is equal to or less than the first set curvature and forms a third angular section from the starting point of the third elliptical section.

### TECHNICAL FIELD

The present invention relates to an asymmetric elliptical chain ring for a clipless pedal, more particularly, an asymmetric elliptical chain ring capable of transferring driving force of both right and left legs by stepping on the chain ring while pulling the same in order to use a clipless pedal, unlike a general flat pedal in a bicycle to transfer driving force by stepping on the pedal with either leg.

### BACKGROUND ART

The statement of this section has been prepared to promote understanding of the background art of the present invention, and may include information other than prior art known by persons having ordinary skill in the art (‘those skilled in the art’).

The conventional symmetric elliptical chain ring disclosed in U.S. Pat. No. 7,749,117 was provided to remove a dead point occurring in a flat pedal by positioning the shortest side at a start point of approximately the 1 o'clock position (1 h) as a crank angle.

As illustrated in FIGS. 2a and 2b, the above device is characterized by placing the longest side at a desired site to avoid the start point at the 1 o'clock position (1 h), which is a crank angle causing a high risk of knee injury, and form a maximum output section before and after a start point at the 4 o'clock position (4 h). Such concentration of the output sections causes output loss sections at the start point between 4 o'clock (4 h) and 7 o'clock (7 g) positions, and between 10 o'clock (10 h) and 1 o'clock (1 h) positions. Therefore, the above device could not serve as a suitable elliptical chain ring in a clipless pedal requiring back stroke and forward stroke.

On the other hand, as shown in FIG. 2c, U.S. Pat. No. 55,549,114 has described that crank resistance occurs from the start point of the 5:30 position (5 h30 m). This enables back stroke driving using the clipless pedal, while having forward stroke at the start point of the 11:30 position (11 h30 m).

However, there is loss of resistance at both of the start point between the 4:00 (4 h) and 5:30 (5 h30 m) positions and the start point between the 10:00 (10 h) and 11:30 (11 h30 m) positions, hence limiting participation of related muscles in the corresponding sections. Herein, since demerits of noise and low transmission properties due to a high curvature of more than 1.2 are entailed, the above device is exclusively used by only some players.

On the other hand, as shown in FIG. 2d, in case of a highly skilled athlete, although the circular chain ring would sometimes show the output decreased at the start point of approximately the 6 o'clock position (6 h) and the 12 o'clock position (12 h), the output never completely comes to a pause such as running of a non-athlete. In other words, at least a certain range of output is generated in each of all sections around 360 degrees (°) wherein the crank is driven.

As shown in FIG. 2d, several years of training are required to prepare graphs for athletes, and it is commonly known that such pedaling is more difficult than four strokes of swimming. This is because cyclist peak in their early 30s, compared to early 20s for swimmers.

FIG. 2c exhibits generation of uniform output in a stroke volume shape targeted by the present invention over 360° crank motion sections. Therefore, such pedaling may uniformly use the corresponding muscles in each section to increase muscle distribution of the lower body muscles, thereby reducing load applied to the corresponding muscles. That is, it is possible to ride thousands of km over several days, such as in the Tour de France cycling race. In addition, as shown in FIG. 2d, generating the output from more angles may create considerably greater output, compared to non-athletes.

A chain ring capable of contriving the graph of a pro-athlete shown in FIG. 2d or the graph shown in FIG. 2e has not existed until now, and therefore, many athletes had to continue one-leg pedaling training named ‘one-leg-drills’.

### DISCLOSURE

### Technical Problem

The present invention has been proposed to solve the problems of the prior art described above, and an object of the present invention is to analyze characteristics of 360° resistance pedaling and use an asymmetric elliptical chain ring to enable 360° resistance pedaling, so that a person can perform 360° resistance pedaling on a bicycle by instinct.

Further, another object of the present invention is to provide six (6) output sections and six (6) muscle changeover sections to connect these 6 output sections in order to perform 360° resistance pedaling in a bicycle so that the user can smoothly perform 360° resistance pedaling by instinct.

### Technical Solution

An asymmetric elliptical chain ring for a clipless pedal according to one embodiment of the present invention may include first to third elliptical sections, which are inserted and fixed in a crankshaft, and formed counterclockwise, respectively, wherein a slope at each imaginary point of first and second elliptical sections increases counterclockwise, a slope at each imaginary point of third electrical section decreases counterclockwise, and a virtual center line in a longitudinal direction of a crank arm toward the pelvis of a human body is positioned to have a set angle in the counterclockwise direction from a start point of the first elliptical section, wherein: the start point of the first elliptical section is the shortest distance from a center of an asymmetric ellipse, has a curve with a first set curvature or less and forms a first angle section from the start point of the first elliptical section; a start point of the second elliptical section meets with an end point of the first elliptical section positioned within a first muscle changeover section while an end point of the second elliptical section is the longest distance from the center of the asymmetric ellipse, a curvature of the second elliptical section is equal to or greater than the first set curvature, and the second elliptical section forms a second angle section from the start point of the second elliptical section; and a start point of the third elliptical section is an end point of a second muscle changeover section positioned between the start point of the third elliptical section and the end point of the second elliptical section, and a curvature of the third elliptical section is equal to or smaller than the first set curvature and forms a third angle section from the start point of the third elliptical section.

In this regard, the first set curvature may be more than 1.0 and not more than 1.02, while the first angle section may be positioned at 45 to 58°.

Further, the second angle section may be positioned at 50 to 60°.

Further, the second set curvature may be more than 1.0 and not more than 1.03.

Further, the first muscle changeover section may have a curvature which is smaller than that of each curve of the first elliptical section and the second elliptical section but greater than that of a straight line to connect the start point and the end point of the first muscle changeover section.

Further, the first muscle changeover section is positioned at 6 to 12° in the counterclockwise direction from the first angle section.

Further, the start point of the second muscle changeover section is positioned at 110 to 120° from the start point of the first elliptical section, while the end point of the second muscle changeover section is positioned at 7 to 14° from the start point of the second muscle changeover section.

Further, the end point of the third elliptical section is the start point of the third muscle changeover section, and the start point of the third muscle changeover section is positioned at 165 to 173° from the start point of the first elliptical section while the end point of the third muscle changeover section is positioned at 180° from the start point of the first elliptical section.

### Advantageous Effects

According to the present invention, in order for a person to perform 360° resistance pedaling on a bicycle by instinct, an asymmetric elliptical chain ring is used after analyzing characteristics of 360° resistance pedaling, thereby enabling 360° resistance pedaling.

Further, according to the present invention, in order to accomplish 360° resistance pedaling, 6 output sections and 6 muscle changeover sections to connect the 6 output sections are provided, so that the user can smoothly perform 360° resistance pedaling by instinct.

### DESCRIPTION OF DRAWINGS

FIGS. 1a to 9b are schematic conceptual views illustrating the asymmetric elliptical chain ring for a clipless pedal according to one embodiment of the present invention.

### BEST MODE

Advantages and features of the present invention and technical solutions to accomplish the above advantages and features will be obviously understood with reference to the embodiments concretely described below as well as the accompanying drawings. However, the present invention is not particularly limited to such embodiments and may also be concretely implemented in other different forms. Preferably, the embodiments introduced herein are provided for fully and completely illustrating the subject matters described in the present text and for sufficiently explaining the technical idea of the present invention to those skilled in the art. Therefore, the present invention will be duly defined by the appended claims only.

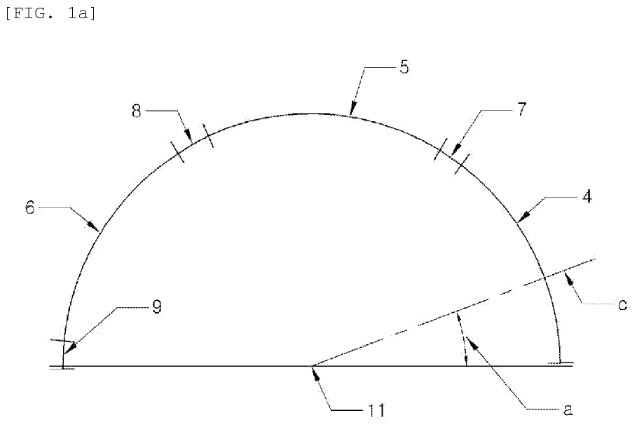

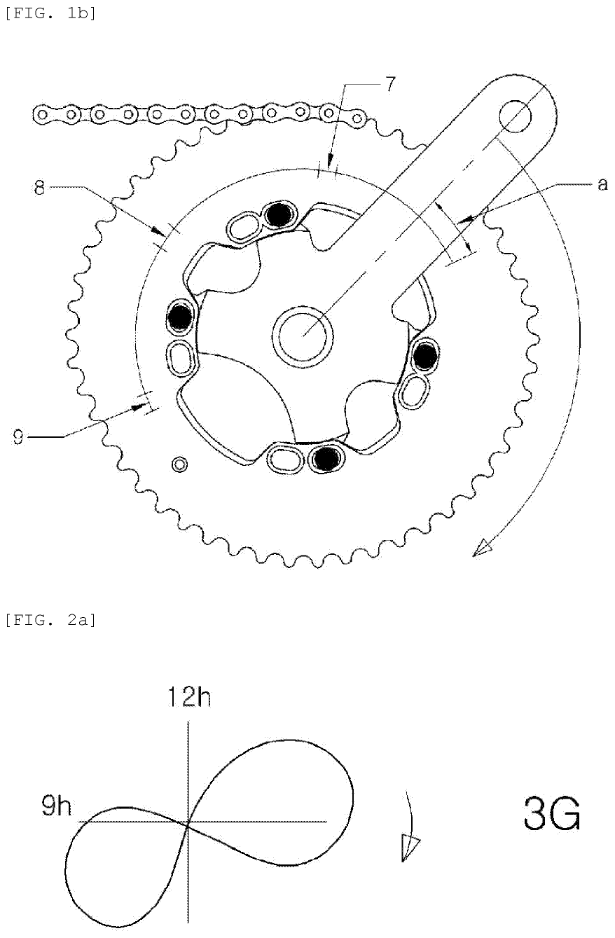

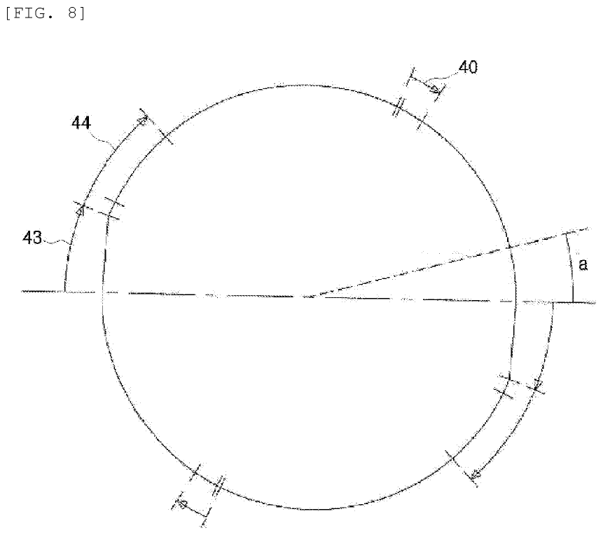

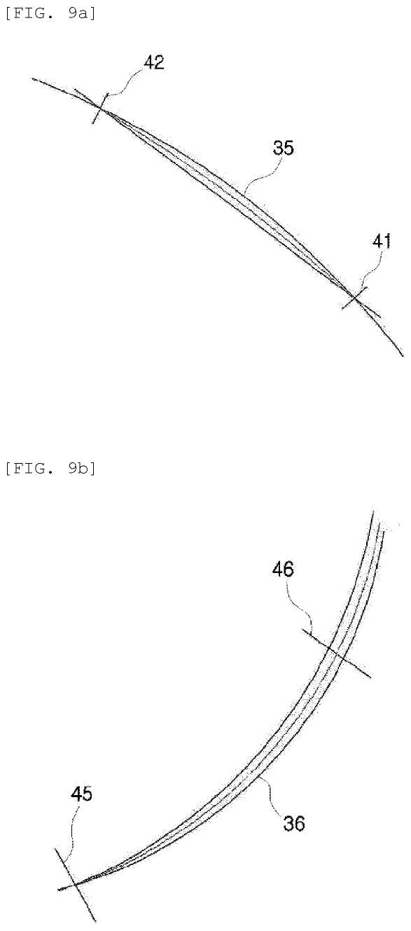

Hereinafter, an asymmetric elliptical chain ring for a clipless pedal according to one embodiment of the present invention will be described in detail with reference to FIGS. 1a to 9b.

The asymmetric elliptical chain ring for a clipless pedal according to the embodiment of the present invention is inserted and fixed in a crankshaft and includes first to third elliptical sections (4, 5, 6) formed counterclockwise, respectively, as shown in FIG. 1a, wherein a second elliptical section (5), a first elliptical section (4) and a third elliptical section (6) have a length increasing in this order.

A slope at each imaginary point of the first and second elliptical sections (4, 5) may increase counterclockwise, while a slope at an imaginary point of the third elliptical section (6) may decrease counterclockwise. A virtual center line (c) in a longitudinal direction of a crank arm toward the pelvis of a human body is positioned to have a set angle (a) (e.g., 15 to 20°) in the counterclockwise direction from a start point of the first elliptical section (4). When the chain contacts the shortest distance from a center of an asymmetric ellipse, the crank arm faces toward the pelvis of a user. The start point of the first elliptical section (4) is the shortest distance from a center (11) of the asymmetric ellipse, has a curve with a first set curvature or less and forms a first angle section from the start point of the first elliptical section (4). The first set curvature may be more than 1.0 and not more than 1.02, while the first angle section may be positioned at 45 to 58°.

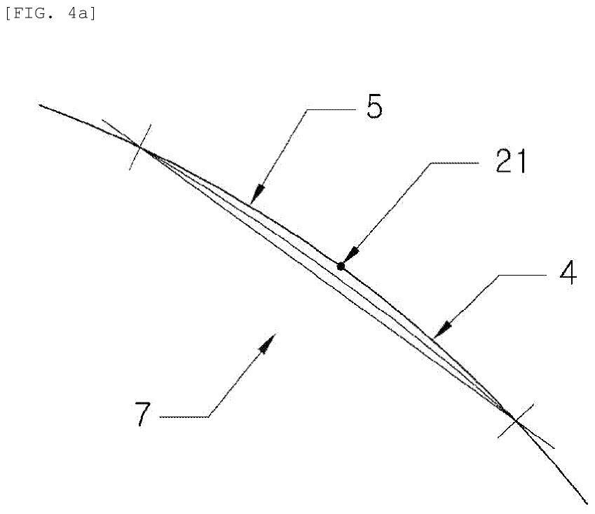

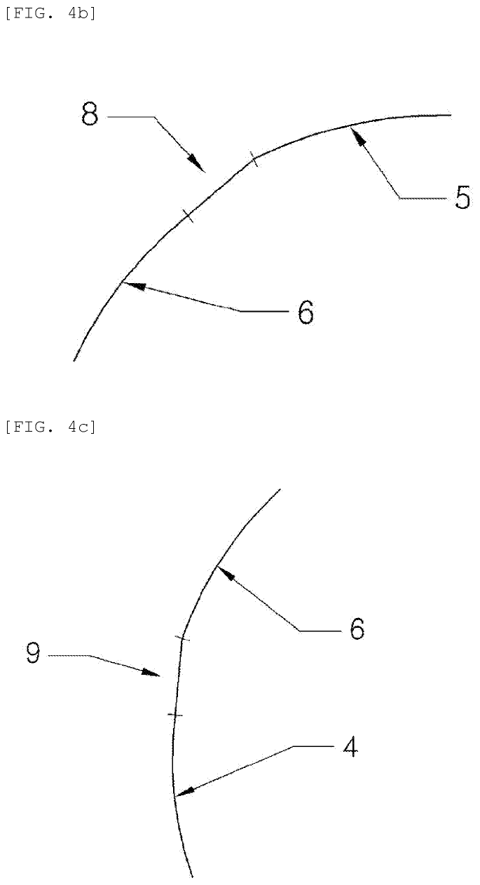

As shown in FIG. 4a, a start point of the second elliptical section (5) meets with an end point of the first elliptical section (4) positioned within a first muscle changeover section (7). The first muscle changeover section (7) may have a curvature which is smaller than that of each curve of the first elliptical section (4) and the second elliptical section (5) but greater than that of a straight line connecting a start point and an end point of the first muscle changeover section (7). The first muscle changeover section (7) may be positioned at 6 to 12° in the counterclockwise direction from the first angle section. An end point of the second elliptical section (5) is the longest distance from the center of the asymmetric ellipse, and a curvature of the second elliptical section (5) is greater than the first set curvature. The second elliptical section (5) forms a second angle section from the start point of the second elliptical section (5). The second angle section may be positioned at 50 to 60°.

A start point of the third elliptical section (6) is an end point of a second muscle changeover section (8) positioned between the start point of the third elliptical section (6) and the end point of the second elliptical section (5). As shown in FIG. 4b, a start point of the second muscle changeover section (8) may be positioned at 110 to 120° from the start point of the first elliptical section (4), while an end point of the second muscle changeover section (8) may be positioned at 7 to 14° from the start point of the second muscle changeover section (8). A curvature of the third elliptical section (6) is smaller than the first set curvature but greater than 1.0. The third elliptical section (6) shows a decreasing curve with negative gradient, and is formed by 180° rotation from the start point of the first elliptical section (4) to the start point of the first angle section rather than 180° symmetry. A third set curvature may be more than 1.0 and not more than 1.02.

The end point of the third elliptical section (6) is a start point of a third muscle changeover section (9). As shown in FIG. 4c, the start point of the third muscle changeover section (9) may be positioned at 165 to 173°, while an end point of the third muscle changeover section (9) may be positioned at 180° from the start point of the first elliptical section (4). Driving resistance of the crank is drastically decreased in the third muscle changeover section (9).

Subject matters illustrated in FIGS. 4b and 4c have common characteristics such that the start point is present at a lower position than a height of the previous elliptical section and thus does not contact the same; and each of the second muscle changeover section (8) and the third muscle changeover section (9) has a linear form or a random curved shape.

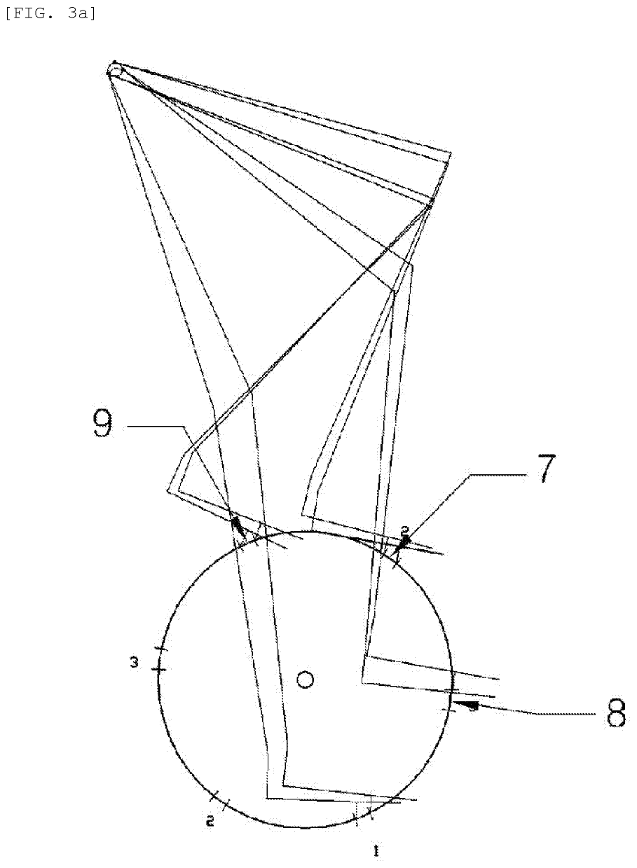

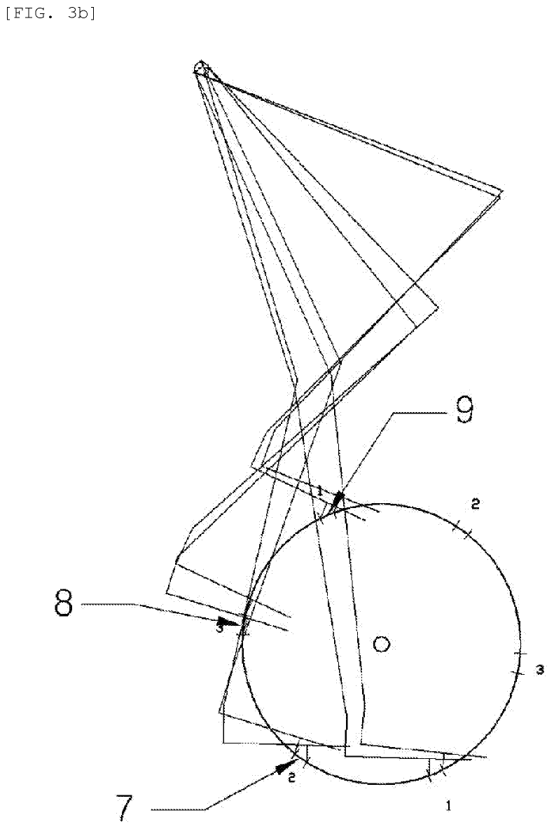

With reference to the illustration in FIGS. 1a and 1b, for example, motion of the clipless pedal driven by the lower body of a human will be described through FIG. 3.

Referring to FIG. 3a, movement of the human body from the third muscle changeover section (9) indicating the start point of the 11 o'clock position to the first muscle changeover section (7) indicating the start point of the 1 o'clock position is illustrated. FIG. 3b is symmetrical to FIG. 3a. A motion section between the third muscle changeover section (9) and the first muscle changeover section (7) is based around quadriceps of thigh of the human body, while another motion section between the start point of the 5 o'clock position and the start point of the 7 o'clock position is based around a hamstring flexor muscle of the human body.

A motion section shown in FIG. 3a is symmetrical to a motion section between the start point of the 7 o'clock position and the start point of the 9 o'clock position in FIG. 3b. Further, a motion section between the start point of the 1 o'clock position and the start point of the 3 o'clock position is based around the quadriceps of the thigh and Gluteus maximus of the human body, while the motion section between the start point of the 7 o'clock position and the start point of the 9 o'clock position is based around the hamstring flexor muscle and Rectus femoris of the human body.

A motion section between the start point of the 3 o'clock position and the start point of the 5 o'clock position shown in FIG. 3a is substantially symmetrical to a motion section between the start point of the 9 o'clock position and the start point of the 11 o'clock position shown in FIG. 3b. The motion section between the start point of the 3 o'clock position and the start point of the 5 o'clock position is based around the Gluteus medius of the human body, while the motion section between the start point of the 9 o'clock position and the start point of the 11 o'clock position is based on Rectus femoris and Iliopsoas muscle of the human body.

According to the embodiment of the present invention, it is described that 6 muscle changeover sections and 6 output sections are set over 360°, wherein each of the output sections includes elliptical curves formed with a negative or positive gradient. Herein, the muscle changeover sections (7, 8, 9) are disposed at both ends reaching each of elliptical sections (4, 5, 6) to form predetermined resistance in the output sections while the resistance is lost in the muscle changeover sections (7, 8, 9), thereby resulting in a cyclic construction.

The embodiment of the present invention may include a forward stroke section with an elliptical curve increasing between the start point of the 11:20 position (11 h20 m) and the start point of the 1:10 position (1 h10 m), as well as a down stroke section with an elliptical curve increasing between the start point of the 1:20 position (1 h20 m) and the start point of the 3:10 position (3 h10 m). Further, the embodiment of the present invention may include a full-down stroke section with an elliptical curve decreasing between the start point of the 3:20 position (3 h20 m) and the start point of the 5:10 position (5 h10 m), as well as a back stroke section with an elliptical curve increasing between the start point of the 5:20 position (5 h20 m) and the start point of the 7:10 position (7 h10 m). Further, an up stroke section with an elliptical curve decreasing between the start point of the 7:20 position (7 h20 m) and the start point of the 8:10 position (9 h10 m) and a full-up stroke section with an elliptical curve decreasing between the start point of the 9:20 position (9 h20 m) and the start point of the 11:10 position (11 h10 m) are also provided.

Between the stroke sections, each of the muscle changeover sections is placed at around 10°. In this case, loss of resistance properly occurs in the muscle changeover section to thus result in a change in angle of an ankle, as shown in FIGS. 3a and 3b. On the other hand, the angle of the ankle in each stroke section may remain constant with the calf.

Referring to FIGS. 3a and 3b, cross-reciprocation angular movement of the human thighbone is not an angular motion with symmetrical angular velocity, and therefore, a position of the thighbone is not symmetrical at a crank symmetric point. This is more clearly revealed in 6 muscle changeover sections. Because of such asymmetric angular motion of the thighbone, pedaling with both legs has separate mobility which is not dependent on one leg.

Due to such separate mobility of both legs, athletes or high skill cyclists consider that one-leg pedaling training is an essential course. For this 360° resistance pedaling, the 6 muscle changeover sections and the 6 elliptical sections are arranged in 180° symmetry so that any ordinary person can also easily experience one-leg pedaling and also perform 360° resistance pedaling with both legs.

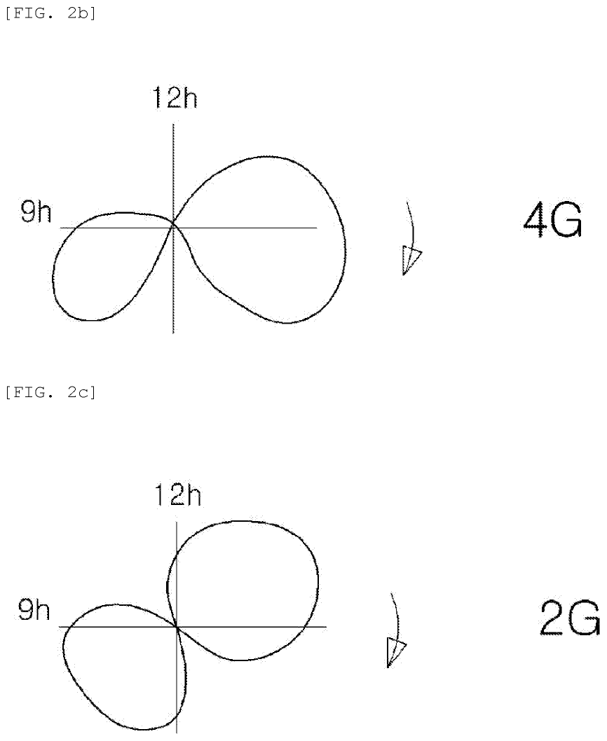

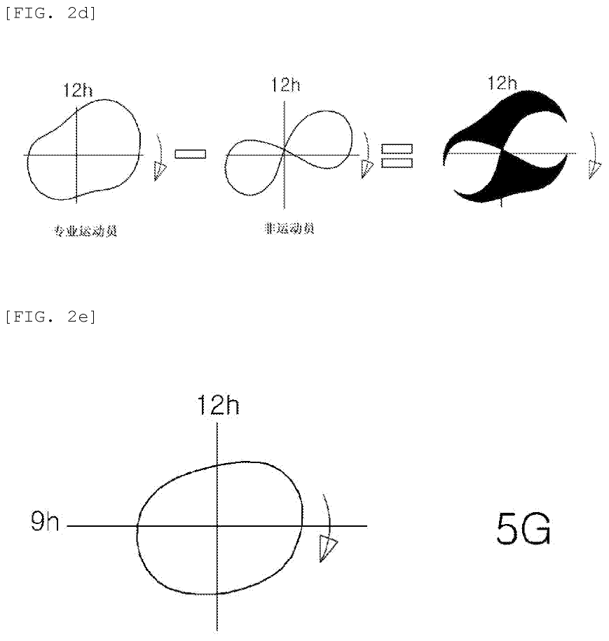

Therefore, according to the embodiment of the present invention, the stroke volume graph as shown in FIG. 2e may be prepared in regard to 360° resistance pedaling by a person. The maximum muscle distribution may be achieved using a greater variety of muscles in the human lower body so as to increase lipid metabolism and improve endurance, thereby generating high output over 360°.

According to the embodiment of the present invention, in order for a user to perform 360° resistance pedaling in a bicycle by instinct, after analyzing characteristics of the 360° resistance pedaling, an asymmetric elliptical chain ring may be used to enable 360° resistance pedaling. For this purpose, a driving portion is divided into 6 sections and these driving sections are characterized in that different muscles are involved, respectively, and a direction of force is varied.

Meanwhile, in case of a circular chain ring, it is interpreted as having four (4) driving sections which are classified into down stroke, back stroke, up stroke and forward stroke sections. However, if only such 4 driving sections are adopted, the muscle changeover occurring at the start point of the 3 o'clock position (3 h) and the start point of the 9 o'clock position (9 h) cannot be interpreted, hence entailing limitations.

In order to overcome such limitations, the embodiment of the present invention may prepare 6 output sections and 6 muscle changeover sections connecting the same in order to perform 360° resistance pedaling, so that a user can smoothly perform 360° resistance pedaling by instinct.

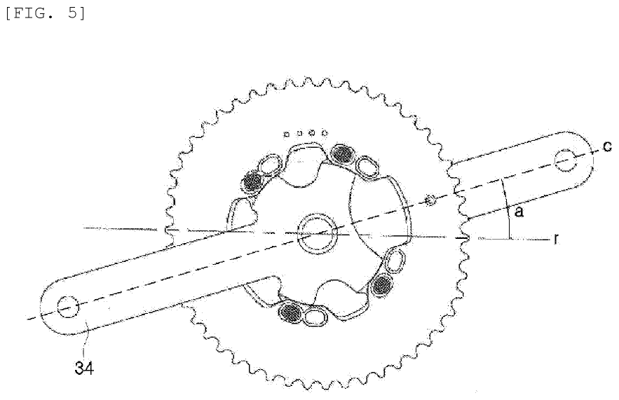

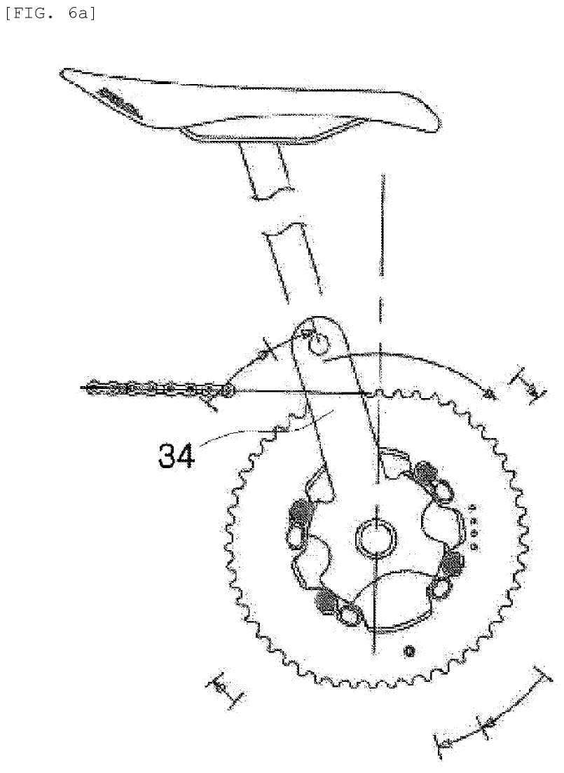

Hereinafter, an asymmetric elliptical chain ring for a clipless pedal (‘cleat pedal’) according to another embodiment of the present invention will be described in detail with reference to FIGS. 5 to 9b.

The asymmetric elliptical chain ring for a cleat pedal in a bicycle according to the embodiment of the present invention is inserted and fixed in a crankshaft and may include first and second elliptical sections (35, 36), as shown in FIG. 5.

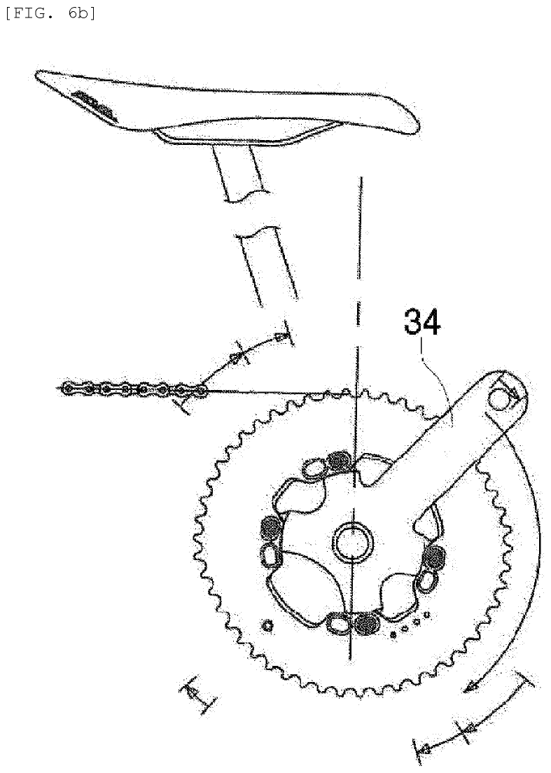

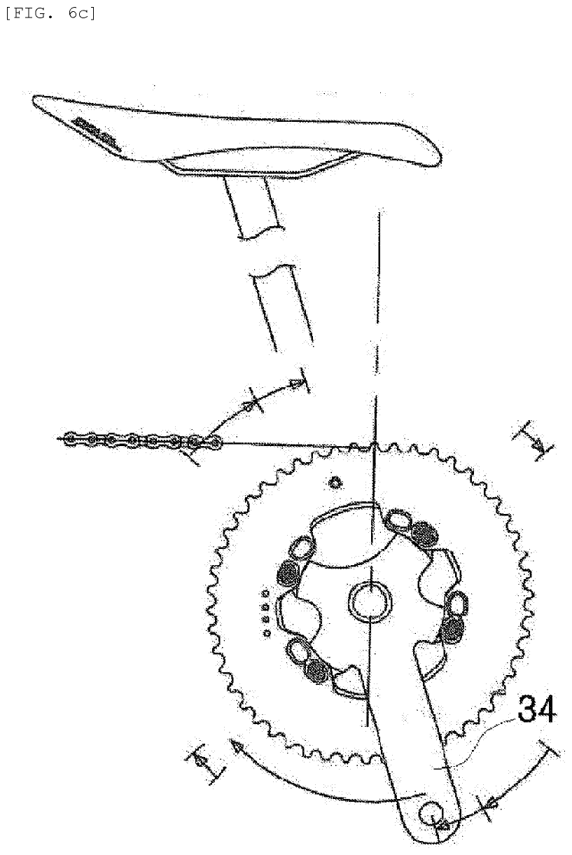

A virtual center line (c) in a longitudinal direction of a crank arm 34 may be positioned to have a set angle (a) (e.g., to 30°) in counterclockwise direction from a set reference line (r). FIGS. 6a to 6d illustrate a clockwise rotating process of the crank arm 34 (FIGS. 6a, 6b, 6c, 6d).

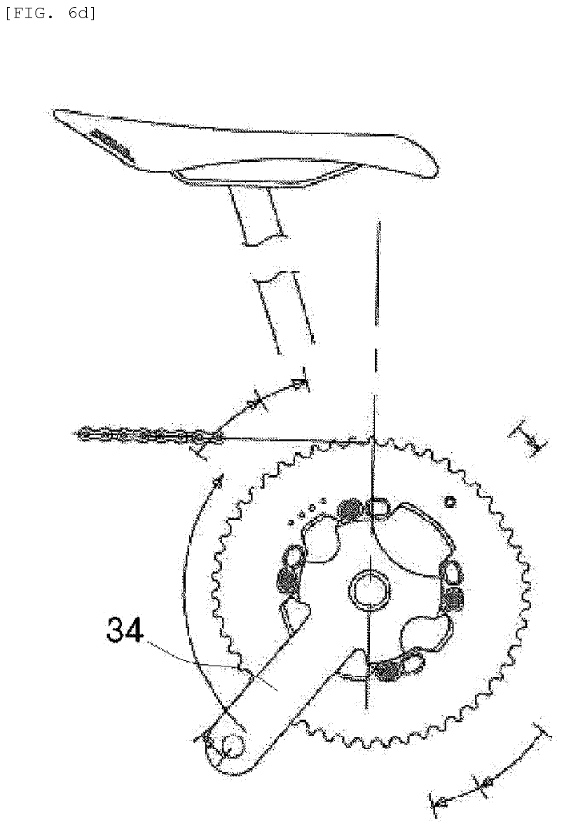

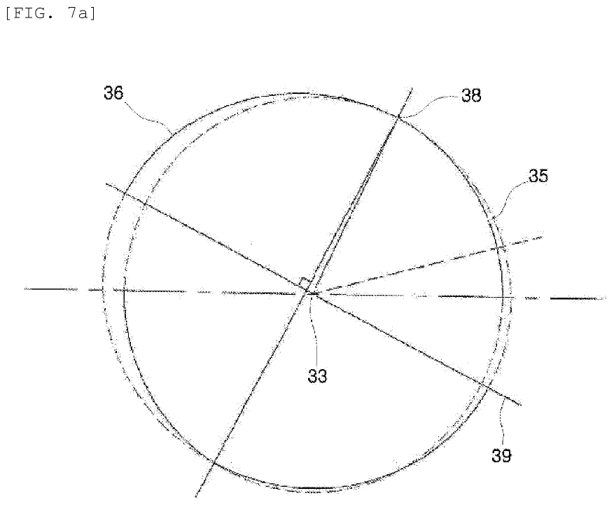

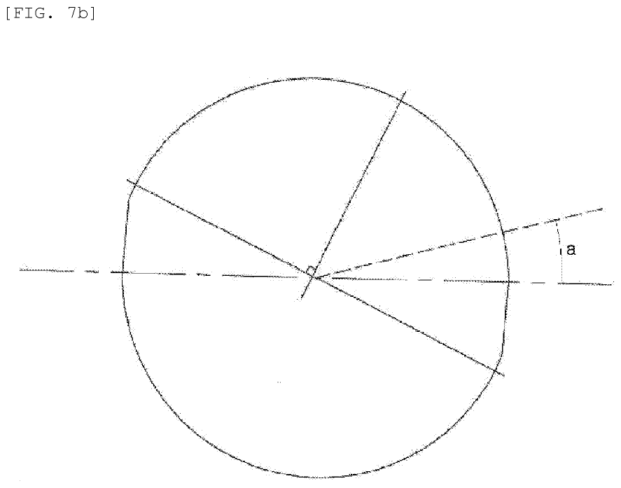

As shown in FIG. 7a, the first elliptical section 35 is a circle or an ellipse having a curvature of 10% or less. A second elliptical section (36) may be formed to have a center on a straight line (39) that is parallel to the tangent at a contact point (38) on the first elliptical section (35) having 55 to 75° from the set reference line (r) and passes through the center (33) of the first elliptical section. Since a long side of the second elliptical section (36) is placed on the straight line (39), the first elliptical section (35) and the second elliptical section (36) may be combined.

In the pedaling shown in FIGS. 6a to 6d, 8, 9a and 9b, a second buffer section (40) for transition from simultaneous kicking and dragging motion to simultaneous stepping and pulling motion may be formed at +10 to −20° around the contact point (38) on the first elliptical section (35). By drawing a random curve which is positioned above a straight line connecting a first starting point (41) and a first finishing point (42) of the second buffer section (40) while being below an elliptical curve connecting the first starting point (41) and the first finishing point (42), the first starting point (41) and the first finishing point (42) may be connected by the drawn curve.

During the simultaneous stepping and pulling motion in the pedaling, a third buffer section (44) for entry to a first buffer section (43) is set to +35° to −35° or less around the long side of the second elliptical section (36), and a circle being in contact with a second starting point (45) and a second finishing point (46) of the first buffer section (43) and present on a long side axis of the second elliptical section (46) or the third buffer section (44) greater than the above circle and smaller than the longest side of the second elliptical section (36) may connect the second starting point (45) and the second finishing point (46).

The first buffer section (43) provided for converting a stepping and pulling force into a dragging and kicking force in the pedaling movement may be formed in a straight line or a random circular arc to a short side of the first elliptical section (35) at the finishing point (46) of the third buffer section (44) and is subjected to conditions of a general asymmetric ellipse.

As such, two further sections for converting force in the pedaling may be added to a combination of the first elliptical section and the second elliptical section having such basic structure as described above. Herein, smoothly converting the force may prevent injury.

According to another embodiment of the present invention, in order to achieve effects of clipless pedaling, a movement range, that is, an angle of the shortest side and the longest side may be set to a range of 130 to 1580 in order to maximally inhibit loss of force in cross-driving with both legs and attain effects of preventing accumulation of lactic acid in specific muscles. In particular, pedaling using the clipless pedal may generate 20 to 30% higher output, compared to a flat pedal. However, a range of output in the front leg and the rear leg in cross-driving with both legs is not in a symmetric angle (that is, a mirror angle). Therefore, the movement range must be defined as broad as possible.

For this purpose, in order that the rear leg enters the first elliptical section and the second elliptical section forms an area on which the front leg steps, a curvature of each elliptical section and an angle of a contact point should be organically combined.

In such basic configuration, an alternative section to buffer a change in force of a human body is needed at the contact point between the first elliptical section and the second elliptical section, while the change in force of the human body must also be buffered in the long side of the second elliptical section.

A common feature of the above two sections is that loss of resistance is encountered. Since a curve having a smaller radius than the existing elliptical curve is adopted, even the angle of an ankle may be stabilized so that the outputs of the thigh and buttocks could be completely transferred to the pedal. Therefore, such two buffer sections as described above are absolutely required to efficiently transfer human force to the crank in circular motion.

The aforementioned embodiments of the present invention have been described with reference to the exemplary embodiments illustrated in the drawings in order to better understand the present invention, however, these are provided for illustrative purposes only. Therefore, those skilled in the art will appreciate that a variety of modifications and other equivalent embodiments may be possible based on the above description. Therefore, the true technical scope of the present invention is duly defined by the appended claims.

1. An asymmetric elliptical type chain ring for a clipless pedal, comprising
first to third elliptical sections which are inserted and fixed in a crankshaft, and formed counterclockwise, respectively,
wherein a slope at each imaginary point of first and second elliptical sections increases counterclockwise,
a slope at an imaginary point of third electrical section decreases counterclockwise, and
a virtual center line in a longitudinal direction of a crank arm toward the pelvis of a human body is positioned to have a set angle in a counterclockwise direction from a start point of the first elliptical section, wherein:
the start point of the first elliptical section is a shortest distance from a center of the asymmetric ellipse, has a curve with a first set curvature or less and forms a first angle section from the start point of the first elliptical section;
a start point of the second elliptical section meets with an end point of the first elliptical section positioned within a first muscle changeover section while an end point of the second elliptical section is a longest distance from the center of the asymmetric ellipse, a curvature of the second elliptical section is equal to or greater than the first set curvature, and the second elliptical section forms a second angle section from the start point of the second elliptical section; and
a start point of the third elliptical section is an end point of a second muscle changeover section positioned between the start point of the third elliptical section and the end point of the second elliptical section, and a curvature of the third elliptical section is equal to or smaller than the first set curvature and forms a third angle section from the start point of the third elliptical section.

2. The asymmetric ellipse type chain ring according to claim 1, wherein the first set curvature is more than 1.0 and not more than 1.02, while the first angle section is positioned at 45 to 58°.

3. The asymmetric ellipse type chain ring according to claim 1, wherein the second angle section is positioned at 50 to 60°.

4. The asymmetric ellipse type chain ring according to claim 1, wherein the second set curvature is more than 1.0 and not more than 1.03.

5. The asymmetric ellipse type chain ring according to claim 1, wherein the first muscle changeover section has a curvature which is smaller than that of each curve of the first elliptical section and the second elliptical section but greater than that of a straight line to connect a start point and an end point of the first muscle changeover section.

6. The asymmetric ellipse type chain ring according to claim 5, wherein the first muscle changeover section is positioned at 6 to 12° in the counterclockwise direction from the first angle section.

7. The asymmetric ellipse type chain ring according to claim 1, wherein a start point of the second muscle changeover section is positioned at 110 to 120° from the start point of the first elliptical section, while the end point of the second muscle changeover section is positioned at 7 to 14° from the start point of the second muscle changeover section.

8. The asymmetric ellipse type chain ring according to claim 1, wherein an end point of the third elliptical section is the start point of the third muscle changeover section, and the start point of the third muscle changeover section is positioned at 163 to 173° from the start point of the first elliptical section while the end point of the third muscle changeover section is positioned at 180° from the start point of the first elliptical section.
